(19) United States
(12) Patent Application Publication
(10) Pub. No.: US 2024/0020958 A1
(43) Pub. Date: Jan. 18, 2024

(54) SYSTEMS AND METHODS FOR DETERMINING REGIONS OF INTEREST IN HISTOLOGY IMAGES

(71) Applicant: OWKIN, INC., New York, NY (US)

(72) Inventors: Olivier DEHAENE, Paris (FR); Axel CAMARA, Paris (FR); Olivier MOINDROT, Paris (FR); Pierre COURTIOL, Paris (FR)

(21) Appl. No.: 18/254,701

(22) PCT Filed: Dec. 3, 2021
(86) PCT No.: PCT/US2021/061891

§ 371 Date: May 26, 2023

(30) Foreign Application Priority Data
Dec. 4, 2020 (EP) 20306505.7

(51) Int. Cl. G06V 10/774; G06V 10/77; G06V 10/762; G06V 10/42; G06V 20/69

(52) U.S. Cl. CPC G06V 10/7753; G06V 10/7715; G06V 10/762; G06V 10/42; G06V 20/695; G06V 2201/03; G06V 10/82

(57) ABSTRACT

A method and apparatus is provided for determining one or more regions of interest in an input histology image. Such methods can include receiving an input histology image, and tiling the input histology image into a set of tiles. In various embodiments, the method can also include, for each tile, extracting a feature of that tile by applying a trained feature extractor. The trained feature extractor can be trained with an unsupervised machine learning algorithm using a training set of images. The method can also include clustering the extracted features to assign each of the set of tiles to one of a plurality of regions of interest for each tile, and outputting the plurality of regions of interest.

### CROSS REFERENCE

This application claims the benefit of European Application No. EP20306505.7 filed Dec. 4, 2020, and the entire content is hereby incorporated by reference.

### FIELD OF INVENTION

This invention relates generally to machine learning (ML) and computer vision and more particularly to image processing and classification.

### BACKGROUND OF THE INVENTION

One of the biggest challenges for applying ML to histopathology is weak supervision. Whole-slide images (WSI) have billions of pixels yet often only one global label. The state of the art therefore relies on strongly-supervised model training using additional local annotations from domain experts. However, in the absence of detailed annotations, most weakly-supervised approaches depend on a frozen feature extractor pre-trained on ImageNet.

### SUMMARY OF THE DESCRIPTION

A method and apparatus of training a feature extractor and determining regions of interest in histology images is disclosed. According to a first aspect, the disclosure relates to a method of training a feature extractor. The method includes receiving a training set of histology images, where each image in the training set of histology images is annotation-free. The method also includes tiling the training set of histology images into a set of tiles. The method also includes performing data augmentation on the set of tiles to generate at least two batches of tiles, where each batch of tiles includes randomly augmented views of the original set of tiles. The method also includes extracting a first set of features from the first batch of tiles; extracting a second set of features from the second batch of tiles; and training the feature extractor using a contrastive loss between pairs of the first set of features and the second set of features to bring matching pairs of tiles closer and different pairs of tiles further apart. In one embodiment, each image in the training set of histology images is a whole slide image. In one embodiment, performing data augmentation includes zooming in on a tile, performing a rotation of a tile, or performing a color augmentation. In one embodiment, tiling the training set of histology images into a set of tiles includes using matter detection to take only tiles from tissue regions of the training set of histology images. In one embodiment, the feature extractor is trained using one of: an unsupervised training model, a self-supervised training model, or a self-supervised training model with contrastive training. In one embodiment, the feature extractor is trained using Momentum Contrast or Momentum Contrast v2. In one embodiment, training the feature extractor includes training the feature extractor for a predetermined number of epochs.

According to a second aspect, the disclosure relates to a method of training a weakly-supervised machine learning model using a trained feature extractor. The method includes receiving a first set of histology images having global labels. The method also includes applying the trained feature extractor described above with reference to the first aspect to the first set of histology images to generate extracted features. The method also includes training the weakly-supervised machine learning model using the features extracted from the first set of histology images having global labels. In one embodiment, the global labels include information from a patient's clinical data or pathology report including survival, response to treatment, or grade classification. In one embodiment, the method also includes analyzing a second set of histology images using the trained weakly-supervised machine learning model, where the second set of histology images does not include annotations. In one embodiment, the method also includes predicting a global label of a patient based on the analysis of the second set of histology images. In one embodiment, the weakly-supervised machine learning model is a multiple instance learning model. In one embodiment, the training set of histology images, the first set of histology images, and the second set of histology images are from the same dataset.

According to a third aspect, the disclosure relates to a method of fine tuning a strongly-supervised machine learning model using the trained feature extractor described above with reference to the first aspect.

According to a fourth aspect, the disclosure relates to a system for training a feature extractor. The system includes an image processor within a processing device. The image processor is configured to receive a training set of histology images, where each image in the training set of histology images is annotation-free. The image processor is also configured to tile the training set of histology images into a set of tiles. The image processor is also configured to perform data augmentation on the set of tiles to generate at least two batches of tiles, where each batch of tiles includes randomly augmented views of the original set of tiles. The system also includes a feature extractor configured to extract a first set of features from the first batch of tiles and extract a second set of features from the second batch of tiles. The image processor is also configured to train the feature extractor using a contrastive loss between pairs of the first set of features and the second set of features to bring matching pairs of tiles closer and different pairs of tiles further apart. In one embodiment, each image in the training set of histology images is a whole slide image. In one embodiment, performing data augmentation includes zooming in on a tile, performing a rotation of a tile, or performing a color augmentation. In one embodiment, tiling the training set of histology images into a set of tiles includes using matter detection to take only tiles from tissue regions of the training set of histology images. In one embodiment, the feature extractor is trained using one of: an unsupervised training model, a self-supervised training model, or a self-supervised training model with contrastive training. In one embodiment, the feature extractor is trained using Momentum Contrast or Momentum Contrast v2. In one embodiment, training the feature extractor includes training the feature extractor for a predetermined number of epochs.

According to a fifth aspect, the disclosure relates to a system for training a weakly-supervised machine learning model using the trained feature extractor. The system includes an input for receiving a first set of histology images having global labels, and the trained feature extractor described above in reference to the fourth aspect. The trained feature extractor generates a number of extracted features from the first set of histology images. The image processor is also configured to train the weakly-supervised machine learning model using the extracted features extracted from the first set of histology images having global labels. In one embodiment, the global labels include information from a patient's clinical data or pathology report including survival, response to treatment, or grade classification. In one embodiment, the trained weakly-supervised machine learning model is configured to analyze a second set of histology images, where the second set of histology images does not include annotations. In one embodiment, the trained weakly-supervised machine learning model is also configured to predict a global label of a patient based on the analysis of the second set of histology images. In one embodiment, the weakly-supervised machine learning model is a multiple instance learning model. In one embodiment, the training set of histology images, the first set of histology images, and the second set of histology images are from the same dataset.

According to a sixth aspect, the disclosure relates to a system for fine tuning a strongly-supervised machine learning model using the trained feature extractor described above in reference to the fourth aspect.

According to a seventh aspect, the disclosure relates to a method of determining a number of regions of interest in an input histology image. The method includes receiving an input histology image, and tiling the input histology image into a set of tiles. The method also includes, for each tile, extracting a feature of that tile by applying a trained feature extractor. The trained feature extractor is trained with an unsupervised machine learning algorithm using a training set of images. The method also includes clustering the extracted features to assign each of the set of tiles to one of regions of interest for each tile. The method also includes outputting the regions of interest. In one embodiment, each of the images in the training set of images are annotation-free. In one embodiment, the input histology image and the training set of images are from the same domain. In one embodiment, the clustering is a K-Means clustering. In one embodiment, the input histology image is a whole slide image. In one embodiment, the input histology image is derived from a patient tissue sample. In one embodiment, the patient tissue sample is known or suspected to contain a tumor. In one embodiment, the unsupervised machine learning algorithm is a self-supervised machine learning algorithm. In one embodiment, the unsupervised machine learning algorithm is a contrastive loss machine learning algorithm including one of Momentum Contrast or Momentum Contrast v2. In one embodiment, the trained feature extractor is a ResNet type of feature extractor. In one embodiment, the method also includes removing background segments from the input histology image. In one embodiment, the method also includes annotating at least one cluster of extracted features. In one embodiment, the method also includes quantifying the input histology image by a level of expression of a number of clusters.

According to an eighth aspect, the disclosure relates to a non-transitory machine-readable medium with a memory storing code instructions which, when executed by a processor, cause the processor to perform operations for determining a number of regions of interest in an input histology image. The operations include receiving an input histology image, and tiling the input histology image into a set of tiles. The operations also include, for each tile, extracting a feature of that tile by applying a trained feature extractor, the trained feature extractor trained with an unsupervised machine learning algorithm using a training set of images. The operations also include clustering the extracted features to assign each of the set of tiles to one of a number of regions of interest for each tile. The operations also include outputting the regions of interest. In one embodiment, each of the images in the training set of images are annotation-free. In one embodiment, the input image and the training set of images are from the same domain. In one embodiment, the clustering is a K-Means clustering. In one embodiment, the input histology image is a whole slide image. In one embodiment, the input histology image is derived from a patient tissue sample. In one embodiment, the patient tissue sample is known or suspected to contain a tumor. In one embodiment, the unsupervised machine learning algorithm is a self-supervised machine learning algorithm. In one embodiment, the unsupervised machine learning algorithm is a contrastive loss machine learning algorithm including one of Momentum Contrast or Momentum Contrast v2. In one embodiment, the trained feature extractor is a ResNet type of feature extractor. In one embodiment, the processor is also configured to remove background segments from the input image. In one embodiment, the processor is also configured to quantify the input histology image by a level of expression of a number of clusters.

According to a ninth aspect, the disclosure relates to a system for determining a number of regions of interest in an input histology image. The system includes an image processor within a processing device. The image processor is configured to receive an input histology image and tile the input histology image into a set of tiles. The system also includes a trained feature extractor for extracting features from each tile. The trained feature extractor is trained with an unsupervised machine learning algorithm using a set of training images. The system also includes a clustering module within the processing device configured to cluster the extracted features to assign each tile to one of a number of regions of interest for each tile. The system also includes an output device to output the regions of interest. In one embodiment, each of the images in the training images are annotation-free. In one embodiment, the input histology image and the training images are from the same domain. In one embodiment, the clustering module utilizes a K-Means clustering. In one embodiment, the input histology image is a whole slide image. In one embodiment, the input histology image is derived from a patient tissue sample. In one embodiment, the patient tissue sample is known or suspected to contain a tumor. In one embodiment, the unsupervised machine learning algorithm is a self-supervised machine learning algorithm. In one embodiment, the unsupervised machine learning algorithm is a contrastive loss machine learning algorithm including one of Momentum Contrast or Momentum Contrast v2. In one embodiment, the trained feature extractor is a ResNet type of feature extractor. In one embodiment, the image processor is also configured to remove background segments from the input histology image. In one embodiment, the system also includes a user input device configured to receive an annotation for at least one cluster of extracted features. In one embodiment, the processor is further configured to quantify the input histology image by a level of expression of a number of clusters.

### BRIEF DESCRIPTION OF THE DRAWINGS

The present invention is illustrated by way of example and not limitation in the figures of the accompanying drawings in which like references indicate similar elements.

FIG. 1 illustrates an example system for using self-supervised learning on histology images to train a feature extractor, according to embodiments of the present disclosure.

FIG. 2 is a flow diagram of one embodiment of a process for using self-supervised learning on histology images to train a feature extractor, according to embodiments of the present disclosure.

FIG. 3 illustrates an example system for training a multiple instance learning (MIL) algorithm with weakly supervised learning, according to embodiments of the present disclosure.

FIG. 4 is a flow diagram of one embodiment of a process for identifying regions of interest in a histology image, according to embodiments of the present disclosure.

FIG. 5A illustrates an annotated histology slide, according to an embodiment of the present disclosure.

FIG. 5B illustrates the best performing cluster achieved using out-of-domain images as training images.

FIG. 5C illustrates the best performing cluster achieved using in-domain images and a self-supervised ML algorithm, according to embodiments of the present disclosure.

FIG. 6A illustrates another annotated histology slide, according to an embodiment of the present disclosure.

FIG. 6B-6D illustrate best matching clusters achieved using in-domain images and a self-supervised ML algorithm, according to embodiments of the present disclosure.

FIG. 7 shows a cluster of five most representative tiles showing tumoral tissue, among 10 clusters, according to an embodiment of the present disclosure.

FIG. 8 shows a set of three clusters of tiles, according to an embodiment of the present disclosure.

FIG. 9 illustrates one example of a computer system, which may be used in conjunction with the embodiments described herein.

### DETAILED DESCRIPTION

A method and apparatus of a device that determines regions of interest in a histology image are disclosed. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

From this disclosure, it should be understood that the invention is not limited to the examples described herein. Indeed, the methods and techniques disclosed herein can be applied to any kind of inputted image, for the task(s) of either classification, predicting a global score, and/or identifying one or more region(s) of interest within the inputted image, in any technical field requiring semantic segmentation of large images.

In the context of medicine, and more particularly histology, one embodiment of the present disclosure aims at providing various diagnosis information to a pathologist. Thus, said input image can be a histology image, but any visual representation of a tissue or portion thereof can be used. For example, the input image can be a visual representation of a tissue section obtained from a frozen or paraffin-embedded tissue sample. In some embodiments, the input image can be a whole slide image (WSI). In some embodiments, the input image can comprise a tissue section that has been stained to visualize the underlying tissue structure, for example, with hematoxylin and eosin (H&E). Other common stains that can be used to visualize tissue structures in the input image include, for example, Masson's trichome stain, Periodic Acid Schiff stain, Prussian Blue stain, Gomori trichome stain, Alcian Blue stain, or Ziehl Neelsen stain.

As used herein, the “region of interest” of an image could be any region semantically relevant for the task to be performed. In various embodiments, a region of interest can correspond to tissues, organs, bones, cells, body fluids, etc. In some embodiments, in the context of histopathology, a region of interest can be a tumor region, that is, a region comprising tumor cells. Other regions of interest can include, but are not limited to, a normal (e.g., non-tumor) region, a fibrotic region, a region comprising stromal cells or tissue, a region comprising epithelial cells or tissue, and/or a region comprising endothelial cells or tissue.

As used herein, classifying an image describes associating to a particular image a label from a predetermined list of labels. In the context of histopathology, the classification could be a diagnosis classification. In one embodiment, the classification can be binary, e.g., the labels are simply “healthy”/“not healthy,” e.g., “cancer”/“not cancer.” In another embodiment, there could be more than two labels, for example labels corresponding to different diseases, labels corresponding to different stages of a disease, labels corresponding to different prognostic categories (e.g., expected disease outcome, expected duration of survival, expected drug responsiveness, etc.), labels corresponding to different kinds of diseased tissue, etc.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in a different order. Moreover, some operations may be performed in parallel rather than sequentially.

The terms “server,” “client,” and “device” are intended to refer generally to data processing systems rather than specifically to a particular form factor for the server, client, and/or device.

In one embodiment of the present disclosure, an in-domain feature extractor is trained on histology images using a self-supervised contrastive loss ML algorithm, such as Momentum Contrast (MoCo), MoCo v2, and/or other types of self-supervised contrastive loss algorithms. The public Cancer Genome Atlas (TCGA) provides a dataset of thousands of tissue slide images of cancers of various organs. Another example dataset that can be used is Camelyon16, which includes WSIs taken from sentinel lymph nodes, which are either healthy or exhibit metastases of some form. Experimental results on Camelyon16 and TCGA show that the proposed extractor greatly outperforms its ImageNet counterpart (which includes annotated images). In particular, results described in the present disclosure improve the weakly-supervised state of the art on Camelyon16 from 91.4% to 97.7% area under the curve (AUC), thereby closing the gap with strongly-supervised models that reach 99.3% AUC. Through the examples and embodiments disclosed herein, it can be demonstrated that feature extractors trained via self-supervised learning can act as drop-in replacements to significantly improve existing ML techniques in histology. Lastly, the present disclosure demonstrates that the learned embedding space exhibits biologically meaningful separation of tissue structures.

Histopathology is the gold standard for diagnosis in many diseases, and especially in oncology. One example of a routine task performed by pathologists is metastasis detection in hematoxylin and eosin (H&E) stained slides of lymph nodes, which can prove challenging as whole-slide images (WSI) can be over 25 mm wide while micro-metastases can be as small as 50 μm wide. However, in most existing cohorts, WSIs are only associated with a pathology report containing global labels, but that lacks detailed pixel-level annotations. In the example above, a lymph node slide would only have a binary slide-level label indicating whether it contains any metastasis.

Despite these limitations, recent work has demonstrated that ML can perform well on histology images, sometimes as well as human experts. Models that attempt to learn directly from global labels belong to the field of weakly-supervised ML, and have to propagate the slide-level information down to individual pixels of the WSI. In one example, a weakly-supervised model can be trained using images with global or slide-level annotations or labels, and the model can then infer local or pixel-level information within the images. In contrast, strongly supervised models utilize pixel-level or local annotations in addition to the global labels. However, these pixel-level and/or local annotations (e.g., pathologist annotations) can be costly and time-consuming. For example, a strongly-supervised model may include classic computer vision models trained with tiles as input, and with tile labels as output. In such a strongly-supervised model, tile annotations are required. Three examples of weakly-supervised models are cited below, and include Chowder, Weldon, and DeepMIL.

By taking advantage of added information from pixel-level and/or local annotations, strongly-supervised models often perform better than weakly-supervised ones. On Camelyon16, the state of the art for breast cancer metastasis detection is strongly-supervised and reaches an area under the ROC curve (AUC) of 99.3%. This state of the art utilized a convolutional neural network (CNN) trained on tile annotations. Without annotations and despite many recent advances, weakly supervised learning on Camelyon16 only achieves 91.4% AUC. This result was achieved using CLAM, which is a method that uses contrastive predictive coding (CPC) as a feature extractor. However, other research questions in histology consist in predicting a global label that is not directly visible in the slide, such as the information from a patient's clinical data or pathology report, which can include overall survival of the patient, gene expression from transcriptomic data, response to treatment, grade classification, etc. In these situations, annotations can provide helpful regions of interest but are not enough to solve the task itself. For example, pathologist annotations may identify helpful regions, but it may not be clear which annotations or biomarkers would be indicative of overall survival. In such cases, weakly-supervised learning remains a key method for ML in histology.

Another challenge for weakly-supervised ML is that current constraints on GPU memory prevent full end-to-end learning, as a high-resolution input WSI size can be up to 8 GB or greater. In some embodiments, weakly-supervised ML approaches rely on a pre-processing step to reduce the dimensionality or size of the input, often separating the slide into smaller images (tiles) on which conventional architectures, such as a convolutional neural network (CNN), can operate. This network, the feature extractor, can be either fine-tuned or frozen, but in both cases, the network is often pre-trained on ImageNet, which is an out-of-domain dataset. Images that are out-of-domain include images that are of a different category or class than those being analyzed. For example, if a model is used to analyze histology slides, but includes a feature extractor that is trained on ImageNet (which includes images of animals, trees, houses, etc.), then that feature extractor has been trained on out-of-domain images.

The present disclosure identifies the use of out-of-domain pre-training as a significant weakness in current weakly-supervised methods. In one embodiment, the present disclosure is directed to training a new in-domain encoder or feature extractor on histology tiles using a self-supervised learning algorithm. Recent advances have significantly improved the transfer learning performance of unsupervised pre-training. In one example embodiment, one such state-of-the-art self-supervised algorithm, MoCo v2, is used to train a tile-level feature extractor without supervision. In some embodiments, this approach can be well suited to histology, since each WSI can include up to tens of thousands of unlabeled tiles. Unsupervised learning is a field of machine learning that looks for patterns in a data set without pre-existing labels and without human supervision. Self-supervised learning is a subcategory of unsupervised learning where some type of meaningful signal is automatically generated. For example, in self-supervised learning labels can be generated from the input image itself, rather than from external annotations. In one specific example, different rotations of a single image can be generated, such that a meaningful signal is generated (e.g. a degree of rotation), and this can be used to then predict an angle of rotation.

As discussed above, a number of previous works in histology have relied on pathologists hand-crafted pixel-level annotations to train ML models. For tasks like cancer detection, the slide-level label can be derived from local tumor annotations: if no tumor is found, the slide-level label is negative. For other tasks, such as molecular subtype prediction, the global label is obtained from external data, such as genomic sequencing, and cannot be expressed as purely local information. However, in some embodiments, expert knowledge can be added to the model by annotating regions of interest (the tumor area), which may be seen as a weaker form of strong supervision.

When annotations are not available, in some embodiments, models can be trained with weakly-supervised learning using only the slide-level labels as supervision. One of the most common approaches frames the problem as multiple instance learning (MIL). Weakly-supervised models have been used to predict patient survival in hepatocellular carcinoma or microsatellite instability in colorectal cancer.

GPU memory limitations can prevent full end-to-end learning on WSIs, and most weakly supervised approaches use a frozen feature extractor to reduce the input dimension. In some cases, a streaming neural network can be used to permit end-to-end training, but at the cost of only operating on a down-sampled slide 16,384 pixels wide. The MIL framework has been used to train a network end-to-end by back propagating only on the top tiles. Slide-level labels have also been used directly as local tile labels to train a network.

Over the past two years, rapid developments have been made in the field of self-supervised learning. It has been demonstrated that self-supervised pre-training outperformed supervised pre-training on ImageNet for downstream transfer learning performance. Among the latest self-supervised algorithms, MoCo v2 can work with smaller batch sizes, which makes it a better fit for lower computational resources. However, one skilled in the art will appreciate that various different types of algorithms can be used instead of, or in addition to, MoCo v2. Examples of other self-supervised methods include, but are not limited to: BYOL (bootstrap your own latent), SimCLR (a simple framework for contrastive learning of visual representations), and CMC (contrastive multiview coding). In some embodiments, contrastive predictive coding can be applied to histology images to pre-train a feature extractor.

### Self-Supervised Training of a Feature Extractor

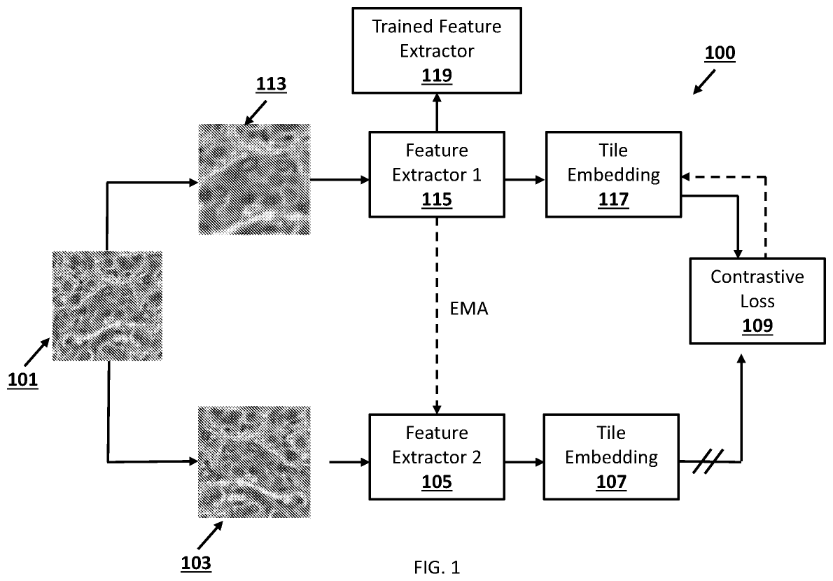

FIG. 1 illustrates an example system 100 for using self-supervised learning on histology images to train a feature extractor, according to embodiments of the present disclosure. In some embodiments, this system 100 can be used to pre-train a feature extractor with self-supervised learning, which can be applied to improve performance in most existing models in histology.

As discussed above, one limitation of prior approaches is the use of a feature extractor trained on out-of-domain data (e.g., ImageNet). According to embodiments of the present disclosure, a better feature extractor is trained on in-domain histology tiles, without annotations. In one embodiment, to apply a self-supervised framework on histology data, tiles are concatenated from all WSIs extracted at the tiling step to form a training dataset. The feature extractor is then trained with MoCo v2 on this set of unlabeled tile images. Initially, a set of tiles 101 can be divided into two batches of tiles. A first batch of tiles 103 and the second batch of tiles 113 can be modified by, for example, adding 90° rotations and vertical flips, and also performing color augmentations. Since histology tiles contain the same information regardless of their orientation, rotations are good augmentations to perform. Because histology tiles are images that contain cells or tissue, and are not orientation dependent, such tiles can be viewed properly without regard for rotations, horizontal flip, etc. Thus, rotating the images provides a valuable augmentation without losing any important characteristics of the image. By applying the batches of tiles 103, 113 to their respective feature extractors 105, 115, tile embeddings 107, 117 can be generated.

In one embodiment, the tile embeddings 107, 117 are the output of the feature extractors, and serve as a signature for each tile that includes semantic information for each tile. In other words, a tile embedding is a representation of a tile that contains semantic information about that tile.

In some embodiments, a self-supervised learning algorithm uses contrastive loss 109 to shape the tile embeddings 107 and 117 such that different augmented views of the same image are close together, or have similar tile embeddings. In other words, contrastive loss 109 can compare the two tile embeddings 107 and 117, and based on that comparison the first feature extractor 115 can be adjusted so that its tile embedding 117 is similar to the tile embedding 107 of the second feature extractor 105. Gradients are back-propagated through the first feature extractor 115. In some embodiments, the second feature extractor's 105 weights are updated with an exponential moving average (EMA) of the first extractor's 115 weights. The use of the EMA can avoid overfitting, in some embodiments. Thus, the output of this system 100 is a trained feature extractor 119, which has been trained using in-domain histology tiles 101 so that tile embeddings 107, 117 of various augmentations of the same image are similar. This type of specifically trained feature extractor 119 can provide significant improvements in downstream performance, as discussed below. In some embodiments, the trained feature extractor can be achieved after training for a certain number of epochs. In some embodiments, training is performed until precision is at or near 1 (or 100%), until the AUC is at or near 1 (or 100%), or until the loss is near zero. In some embodiments, during training of a feature extractor with contrastive loss one may not have access to an abundance of helpful metrics. Thus, one can monitor one of the available metrics of downstream tasks, like AUC, to see how the feature extractor is performing. In one example, a feature extractor that is trained at a certain epoch can be used to train a downstream weakly supervised task in order to evaluate performance. If additional training could result in improved downstream performance, such additional training may be warranted.

In some embodiments, the second feature extractor 105 can be optional, and a single feature extractor 115 can be used to generate the tile embeddings 117, 107 from the two batches of tiles 113, 103. In such an embodiment, one feature extractor is used to generate the tile embeddings 117, 107 from the two batches of tiles 113, 103, and contrastive loss 109 is used, as described above, to compare the two tile embeddings 107 and 117, and adjust the first feature extractor 115 so that the tile embedding 117 is similar to the tile embedding 107.

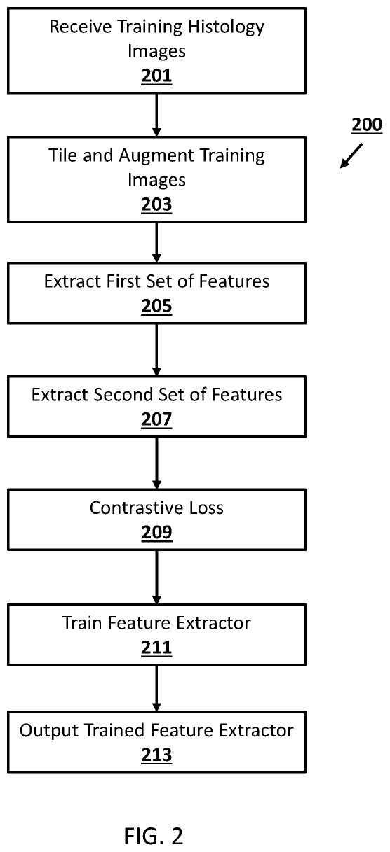

FIG. 2 is a flow diagram of one embodiment of a process 200 for using self-supervised learning on histology images to train a feature extractor, according to embodiments of the present disclosure. In FIG. 2, process 200 begins with receiving a training set of histology images 201. In some embodiments, each image in the training set of images is an annotation-free whole slide image.

At operation 203, the process 200 continues with tiling and augmenting the training set of images into sets of tiles. As discussed above in reference to elements 103 and 113 of FIG. 1, augmentations may be applied to each of the sets of tiles. The process 200 continues with generating a processed set of tiles by, for each batch of tiles selected from the set of tiles, performing the following operations. At operation 205, a first set of features is extracted from a first batch of augmented tiles. At operation 207, a second set of features is extracted from a second batch of augmented tiles. In some embodiments, the augmented tiles include zoomed in or rotated views, or views with color augmentations. For example, since orientation is not important in histology slides, the slides can be rotated at various degrees. The slides can also be enlarged or zoomed in. At operation 209, contrastive loss is used between pairs of the first and second set of extracted features in order to bring matching pairs of tiles closer and different pairs of tiles further apart. Contrastive loss is applied in order to pay attention to positive pairs taken from the first and second set of features, rather than negative pairs.

At operation 211, the process 200 continues with training a feature extractor using the processed set of tiles generated via operations 205-209. In some embodiments, the classification of histology images can be improved using the trained feature extractor disclosed herein. At operation 213, the process 200 continues with outputting a trained feature extractor that has been trained using a self-supervised ML algorithm. In some embodiments, a feature extractor can be trained for a particular number of epochs (e.g., 200 epochs), so that each training image is seen a particular number of times.

### Using a Self-Supervisedly Trained Feature Extractor in Weakly-Supervised Learning

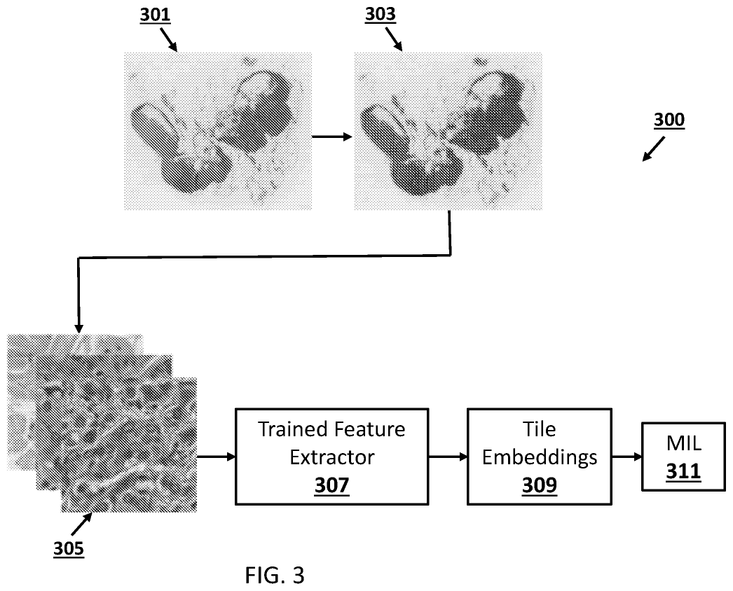

FIG. 3 illustrates an example system 300 for training a multiple instance learning (MIL) algorithm with weakly supervised learning, according to embodiments of the present disclosure. To train deep learning models on histology images with only slide-level labels, a three-step workflow can be used, as shown in FIG. 3. These three levels can include: tiling 303, feature extraction 309, and multiple instance learning (MIL) training 311. Initially, a histology image 301, such as a histology WSI, is tiled 303. In tiling, a grid of N tiles of fixed size at a set zoom level can be extracted from tissue regions. In some embodiments, portions of the tiles that do not include tissue can be removed or disregarded. The total number of tiles N depends on the tissue area in the WSI. A selection of N tiles is shown at 305.

In one embodiment, the trained feature extractor 307 can be the output of process 200, and can correspond to the trained feature extractor 119 in FIG. 1. In other words, the trained feature extractor 307 can be a feature extractor that is trained using a self-supervised ML algorithm using in-domain data or images. This feature extractor 307 extracts D relevant features form each tile, thus obtaining a matrix the size of N×D for each slide. In some embodiments, the relevant features can include (but not limited to) color, shading, or any other descriptors or features in the images. By applying the trained feature extractor 307 to the tiles 305, the tile embeddings 309 are generated. In this example embodiment, the tile embeddings 309 form a matrix of N×D where N is the number of tiles and D is the descriptors or features being extracted. After tile embedding, MIL 313 operates with an N×D matrix as input and a slide-level label as output.

One skilled in the art can appreciate that the techniques described herein, and in particular the self-supervisedly trained feature extractor, can also be used in a strongly-supervised framework, such as where a model is trained using images that have pixel-level annotations. For example, a feature extractor trained using MoCo v2 can be used in both a weakly-supervised setting or a strongly supervised setting. In some embodiments, a feature extractor trained using MoCo v2 can be used with an algorithm such as Chowder v2.

### Interpretability and Clustering

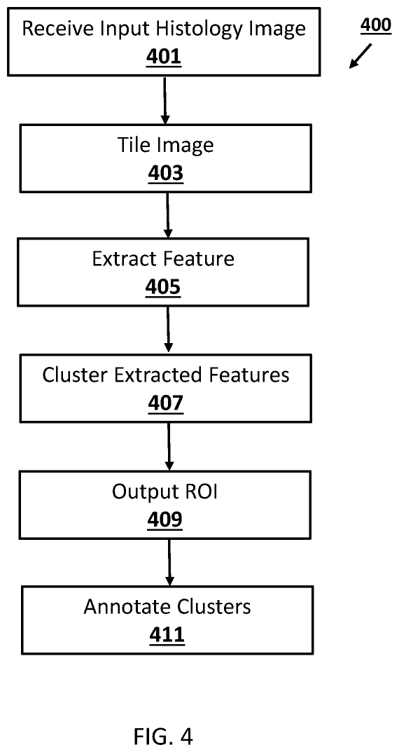

FIG. 4 is a flow diagram of one embodiment of a process 400 for identifying regions of interest in a histology image, according to embodiments of the present disclosure. In FIG. 4, process 400 begins with receiving an input histology image 401. In some embodiments, the input histology image is a WSI, and it can be derived from a patient tissue sample. In some embodiments, the patient tissue sample is known or suspected to contain a tumor.

In some embodiments, the process 400 includes removing background segments from the input image. In some embodiments, matter detection can be used to take only tiles from tissue regions of the input image. In some embodiments, the background can be removed using Otsu's method applied to the hue and saturation channels after transformation of the input image into hue, saturation, value (HSV) color space.

At operation 403, the process 400 continues with tiling the histology image into a set of tiles. In one embodiment, process 400 uses the tiling to increase the ability of preprocessing the images. For example, and in one embodiment, using a tiling method is helpful in histopathology analysis, due to the large size of the whole-slide image. More broadly, when working with specialized images, such as histopathology slides, or satellite imagery, or other types of large images, the resolution of the image sensor used in these fields can grow as quickly as the capacity of random-access memory associated with the sensor. With this increased image size, it is difficult to store batches of images, or sometimes even a single image, inside the random-access memory of a computer. This difficulty is compounded if trying to store these large images in specialized memory of a Graphics Processing Unit (GPU). This situation makes it computationally intractable to process an image slide, or any other image of similar size, in its entirety.

In one embodiment, tiling the image (or the image minus the background) addresses this challenge by dividing the original image (or the image minus the background), into smaller images that are easier to manage, called tiles. In one embodiment, the tiling operation is performed by applying a fixed grid to the whole-slide image, using the segmentation mask generated by the segmentation method, and selecting the tiles that contain tissue, or any other kind of region of interest for the later classification process. In order to reduce the number of tiles to process even further, additional or alternative selection methods can be used, such as random subsampling to keep only a given number of slides.

For example, and in one embodiment, process 400 divides the image (or the image minus the background) into tiles of fixed size (e.g., each tile having a size of 224×224 pixels). Alternatively, the tile size can be smaller or larger. In this example, the number of tiles generated depends on the size of the matter detected and can vary from a few hundred tiles to 50,000 or more tiles. In one embodiment, the number of tiles is limited to a fixed number that can be set based on at least the computation time and memory requirements (e.g., 10,000 tiles).

For each tile, the process 400 continues with extracting 405 one or more features of that tile 405. In one embodiment, each of the features are extracted by applying a trained feature extractor that was trained with a contrastive loss ML algorithm using a training set of images. In one embodiment, the training set of images is a set of annotation-free images. In one embodiment, the input image and the training set of images are from the same domain, meaning that they are of the same category or type of image. For example, the input image and the training set of images can both be histology images. This is in contrast to an embodiment where the training set of images includes out-of-domain images, or images that are not histology images, or are not of the same category or type as the images being analyzed. In one embodiment, the contrastive loss ML algorithm is Momentum Contrast, or Momentum Contrast v2 (MoCo v2). In some embodiments, the trained feature extractor is a ResNet type of feature extractor. The tile embeddings 107, 117 discussed above in reference to FIG. 1 can correspond to the features extracted in operation 405.

At operation 407, the process 400 clusters the extracted features to assign each of the set of tiles to one of a plurality of regions of interest for each tile. In some embodiments, the clustering is K-Means clustering. As mentioned above, the tile embeddings 107, 117 can correspond to the features extracted in operation 405, and the clustering performed at operation 407 can be done on the tile embeddings. In some embodiments, each of the regions of interest is either normal tissue, fibrosis tissue, or tumoral tissue. At operation 409, the process 400 outputs the regions of interest.

At operation 411, the process 400 continues with annotating at least one cluster of extracted features. In some embodiments, the clusters include meaningful groups of images that can be annotated by a pathologist. By clustering the tiles together into meaningful groups, the clusters can be annotated together, thus saving time and resources.

### Examples

The following is a description of a number of specific examples of the embodiments disclosed herein. However, it should be understood that the invention is not limited to the examples described below.

### Improving Downstream Performance Using a Better Feature Extractor

As discussed above, training deep learning models on histology images with only slide-level labels can be done according to the operations shown in FIG. 3, including tiling, feature extraction, and MIL training. However, the quality of such a model can depend on the quality of the trained feature extractor being used.

In one specific example, tiling was performed to generate a grid of N tiles of fixed size at a set zoom level of 0.5 microns per pixel. Rather than using a frozen feature extractor that was pre-trained on out-of-domain data (e.g., ImageNet), a self-supervised ML algorithm using contrastive loss was used to train the feature extractor. In this particular example, the self-supervised ML algorithm used was MoCo v2, and was trained according to the operations described above in reference to FIGS. 1-2. This improved feature extractor, which was trained using MoCo v2 on in-domain images, provides significantly improved performance compared to a frozen feature extractor trained on ImageNet.

Once the feature extractor has been trained using MoCo v2, the extractor can be applied to the tiles to generate tile embeddings, which can then be input to a MIL framework. In this disclosure, three recent approaches following the multiple instance learning (MIL) framework are addressed: Architecture 1, Architecture 2, and Architecture 3. In one example embodiment, Architecture 1 corresponds to the WELDON framework, Architecture 2 corresponds to the CHOWDER framework, and Architecture 3 corresponds to the DeepMIL framework. One common attribute of these architectures is that they all first compute an attention score for each tile of the WSI. In Architecture 1 and Architecture 2, only the minimum and maximum scores are kept and combined into a final prediction. Architecture 3 uses a weighted sum of the tile features using the tile attention scores and computes the prediction using that average representation.

Table 1 illustrates performance for tumor detection (AUC percentage) on Camelyon16 in 5-fold cross-validation (repeated 5 times) on the training set and on the competition test set (5 independent runs). Using the MoCo v2 feature extractor for weakly-supervised learning closes most of the gap with the strongly-supervised state of the art.

TABLE 1

| | Feature Extractor | Train Cross- | Competition |
|---|---|---|---|
| Method | Training Method | Validation | Test Set |
| Strongly Supervised | — | — | 99.3 |
| CLAM | CPC | — | 91.4 ± 2.3 |
| Architecture 1 | Annotated Image | 76.9 ± 16.6 | 65.3 ± 13.7 |
| Architecture 2 | Database | 82.3 ± 15.4 | 79.6 ± 5.1 |
| Architecture 3 | | 88.7 ± 4.7 | 82.9 ± 2.0 |
| Architecture 1 | Self-Supervised | 97.9 ± 1.4 | 97.5 ± 0.4 |
| Architecture 2 | Contrastive Loss | 98.3 ± 1.2 | 97.0 ± 0.5 |
| Architecture 3 | Algorithm | 96.3 ± 2.1 | 97.7 ± 0.4 |

### Experiment 1: Metastasis Detection on Camelyon16

The Camelyon16 challenge involves automatically detecting breast cancer metastases in sentinel lymph node WSIs. AUC for 5-fold cross-validation (repeated 5 times) on the training set and AUC on the hold-out testing set (5 independent runs) are presented in Table 1, above.

The Camelyon16 dataset contains a total of 400 sentinel lymph node H&E-stained WSIs from two medical centers, split into 270 for training and 130 for testing. Local annotations done by pathologists at pixel-level for the slides containing metastases are provided.

In one embodiment, a patch-based classifier can be trained using local tile annotations and tile predictions are combined in a post-processing stage to establish a strongly-supervised state of the art at 99.3% AUC on the test set. On the other hand, the weakly-supervised learning state of the art achieves 91.4% AUC by pre-training the encoder with Contrastive Predictive Coding.

In the examples presented herein, it is demonstrated that switching from a feature extractor trained on ImageNet to one trained with MoCo v2 on Camelyon16 tiles improves results significantly. The same parameters can be used for both experiments, only replacing the feature extractor itself. In one embodiment, a model using the self-supervised learning algorithm disclosed herein obtains 97.7% AUC on the test set, setting a new state of the art for weakly-supervised learning on Camelyon16, which closes the gap with the strongly-supervised baseline at 99.3% AUC.

When training Architecture 1 and Architecture 2 on ImageNet features, performance instability across folds has been observed with standard deviations of 16.6% and 15.4% AUC respectively (see, Table 1). In one embodiment, the standard deviation is divided by a factor of 10 when switching to MoCo v2 features, which demonstrates the robustness and quality of this representation.

### Experiment 2: CMS Classification in Colorectal Cancer

With reference to Table 2, results are described on Consensus Molecular Subtype (CMS) classification on colorectal cancer. The AUC is computed with 5-fold cross-validation, repeated 5 times. All models are trained with multiclass classification, and reported one vs. all AUC for each category, as well as the average AUC (Macro Average).

The TCGA-COAD dataset contains a total of 461 colorectal cancer WSIs. Among these, 364 are classified in one of the four transcriptome-based consensus molecular subtypes (CMS). Baselines used additional tumor annotations to train a model called imCMS only on tumoral tiles. Although these annotations are not directly linked to the CMS labels, they help the model to focus on meaningful regions of the WSI. Their model is trained on TCGA-COAD and an external dataset called FOCUS containing 510 additional slides. In some cases, a weakly supervised approach called DeepHistology can be used that doesn't use any annotation, but obtains lower results, as shown in Table 2.

Table 2 shows performance for Consensus Molecular Subtype (CMS) classification (one vs. all AUC percentage for each subtype, and macro average on all subtypes) on TCGA-COAD in 5-fold cross-validation (repeated 5 times). Changing the ImageNet feature extractor to MoCo v2 improves results substantially. In some embodiments, comparable results to the state of the art can be obtained without using tumor annotations.

TABLE 2

| | Feature Extractor | | | | | Macro |
|---|---|---|---|---|---|---|
| Method | Training Method | CMS1 | CMS2 | CMS3 | CMS4 | Average |
| imCMS | — | 85 ± 5 | 89 ± 3 | 78 ± 7 | 83 ± 4 | 84 ± 3 |
| Deep | Annotated Images | 70 | 69 | 66 | 60 | 66.2 |
| Histology | | | | | | |
| Arch. 1 | Annotated Images | 74.8 ± 7.2 | 68.9 ± 5.1 | 66.9 ± 8.4 | 63.9 ± 7.1 | 68.6 ± 4.3 |
| Arch. 2 | | 75.1 ± 7.0 | 70.9 ± 5.8 | 64.2 ± 7.6 | 63.4 ± 6.5 | 68.4 ± 4.8 |
| Arch. 3 | | 77.4 ± 6.1 | 74.6 ± 5.7 | 73.9 ± 6.3 | 62.5 ± 7.4 | 72.1 ± 4.0 |
| Arch. 1 | Self-Supervised | 87.7 ± 4.7 | 81.9 ± 5.0 | 82.9 ± 5.0 | 68.2 ± 5.9 | 80.1 ± 3.3 |
| Arch. 2 | Contrastive Loss | 86.9 ± 5.4 | 79.9 ± 5.0 | 79.5 ± 6.4 | 66.9 ± 6.6 | 78.3 ± 3.6 |
| Arch. 3 | Algorithm | 88.2 ± 4.4 | 82.7 ± 4.0 | 80.3 ± 5.8 | 68.8 ± 6.2 | 80.0 ± 3.5 |

Similar to results on Camelyon16, switching from ImageNet pre-training to an encoder trained on TCGA-COAD tiles with MoCo v2 increases the AUC by an average of 10 AUC points. Both Architecture 1 and Architecture 3 models outperform the state-of-the-art results of imCMS in CMS1 (88.2% AUC) and CMS3 (82.9% AUC) subtypes, while using less data and no tumor annotations.

On CMS4, the approach disclosed herein succeeds in increasing the AUC. The high infiltration of stromal cells within CMS4 tumors makes it more difficult for the model to focus on the tumor regions. Without local tumor annotations, a weakly-supervised method may struggle to accurately detect CMS4 cases.

### Interpretability and Clustering

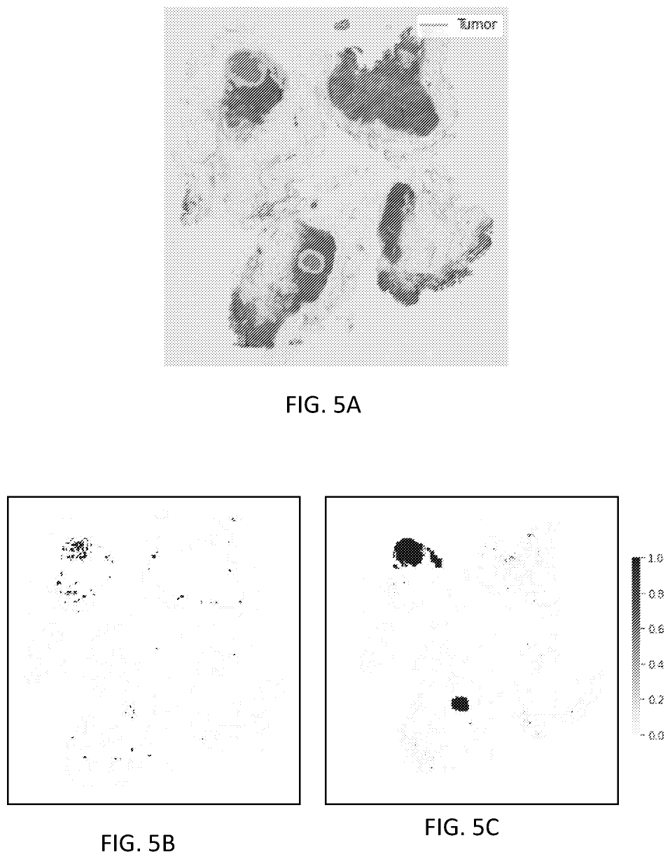

FIG. 5A illustrates an annotated histology slide. FIG. 5B illustrates the best performing cluster achieved using out-of-domain images as training images (i.e. ImageNet), while FIG. 5C illustrates the best performing cluster achieved using in-domain images and a self-supervised ML algorithm. In FIG. 5B, using ImageNet, the best performing cluster among 10 clusters obtained 69.4% AUC. In contrast in FIG. 5C, using MoCo v2, the best performing cluster among 10 clusters obtained 95.1% AUC and matches almost perfectly with the annotations shown in FIG. 5A, while being fully unsupervised.

In one embodiment, a clustering algorithm can be applied to the tile representations. The clustering can include K-Means (k=10) clustering, and can be run on the Camelyon16 training tile features. As a qualitative test, the first slide of the Camelyon16 test set is shown in FIG. 5A, as well as the heat map of the cluster correlated with the tumoral signal for both ImageNet (FIG. 5B) and MoCo v2 (FIG. 5C) features. It can be seen that the best unsupervised MoCo v2 cluster for Camelyon16 tiles (FIG. 5C) almost perfectly matches the tumor annotations, while the ImageNet heat map (FIG. 5B) only covers a portion of the tumor.

In some embodiments, a correlation with the tumoral tissue can be evaluated quantitatively using the local annotations provided within the Camelyon16 dataset. To do so, a similarity ranking is generated per cluster by computing a cosine distance between their features and each centroid. This ranking is then evaluated against the tumoral annotations. The best MoCo v2 cluster achieves 95.1% AUC on detecting tumoral tiles, while the same method on ImageNet-encoded tiles only achieves 69.4% AUC. As shown in FIGS. 5A-5C, without any supervision, MoCo v2 features learn to reliably cluster tumoral tiles.

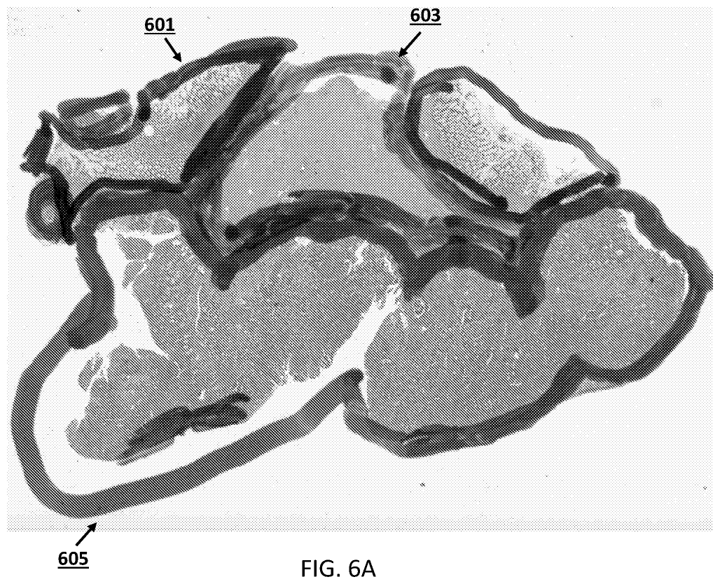

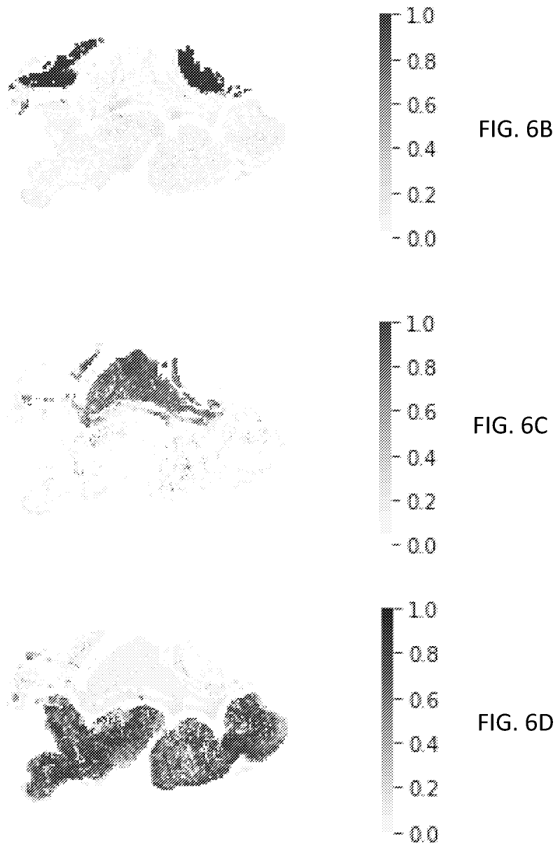

FIG. 6A illustrates an annotated histology slide, according to an embodiment of the present disclosure. FIG. 6B-6D illustrate best matching clusters achieved using in-domain images and a self-supervised ML algorithm, according to embodiments of the present disclosure.

Specifically, FIG. 6A illustrates a slide from TCGA-COAD with rough marker annotations. In these annotations, blue areas 601 show mucosa with normal intestinal glands, green areas 603 show muscularis mucosae and submucosa, and red areas 605 show tumoral tissue. For each color, the best matching cluster on MoCo v2 features among 10 clusters is displayed in FIGS. 6B-6D. FIG. 6B shows the blue areas showing mucosa with normal intestinal glands, FIG. 6C shows green areas with muscularis mucosae and submucosa, and FIG. 6D shows the red areas showing tumoral tissue.

To test if this method generalizes to other datasets, the same clustering principle was applied to the tiles of TCGA-COAD. Some slides in the dataset contain rough marker annotations, as shown in FIG. 6A. Two expert pathologists identified the blue region 601 as mucosa with normal intestinal glands, the green region 603 as muscularis mucosae and submucosa, and the red region 605 as tumoral tissue. Among the 10 tile clusters on MoCo v2 features, 3 clusters were found that match almost perfectly the 3 regions of interest annotated in the slide, as displayed in FIGS. 6B-6D. ImageNet encoded tiles were unable to find meaningful clusters.

In some embodiments, each slide can be characterized or quantified by the level of expression of each cluster. For example, a slide can be quantified as being 50% tumor, 30% fibrosis, and 20% normal.

### Transfer Learning of the Feature Extractor Across Datasets

One potential drawback of the methods disclosed herein is that the training of feature extractor using the self-supervised learning algorithm requires a lot of GPU time. For example, a Camelyon16 encoder took 13 GPU days to train on 2.6 million tiles. Retraining a new feature extractor for every dataset is not always feasible.

In the present disclosure, it is investigated how well a feature extractor trained using a self-supervised ML algorithm, such as MoCo v2, is able to transfer across datasets. In one embodiment, an encoder is trained on Camelyon16 on the Consensus Molecular Subtype classification task, and reciprocally an encoder is trained on TCGA-COAD on the tumoral classification task. For each task, 5 repeated 5-fold cross-validations are performed, resulting in 25 independent runs. In Table 3, it is demonstrated that the feature extractor trained on TCGA COAD transfers very well to Camelyon16, even outperforming by a small margin the original Camelyon16 feature extractor for Architecture 1 and Architecture 2. However, the feature extractor trained on Camelyon16 introduces a significant drop in performance on the CMS prediction task compared to the TCGA-COAD feature extractor. On the CMS classification task, the results of the Camelyon16 feature extractor are on par with results from the ImageNet encoder (see, Table 2).

Table 3 shows cross-validation performance (AUC percentage) when switching feature extractors on Camelyon16 and TCGA-COAD. For each MIL architecture, the performance is displayed without transfer learning (on the diagonal) and the performance with transfer of the feature extractor from the other dataset (o_diagonal).

TABLE 3

| MIL Architecture | Training Dataset | Metastasis | CMS Classification |
|---|---|---|---|
| Architecture 1 | Camelyon16 | 97.9 ± 1.4 | 68.5 ± 4.8 |
| | TCGA-COAD | 98.2 ± 1.0 | 80.1 ± 3.3 |
| Architecture 2 | Camelyon16 | 98.3 ± 1.2 | 67.4 ± 4.3 |
| | TCGA-COAD | 98.6 ± 0.9 | 78.3 ± 3.6 |
| Architecture 3 | Camelyon16 | 96.3 ± 2.1 | 74.5 ± 3.7 |
| | TCGA-COAD | 94.7 ± 3.9 | 80.0 ± 3.5 |

To explain the difference between the differently-trained feature extractors, it is hypothesized that the feature extractor trained on TCGA-COAD was able to capture a much more robust representation, as TCGA-COAD contains slides coming from 24 different centers and is closer to a real-world dataset with variations in slide preparation, staining, and scanning. On the other hand, the Camelyon16 cohort only comes from two different centers and is well curated, which reduces variability. Furthermore, colorectal cancer exhibits a greater variety of histological patterns compared to metastatic lymph nodes.

Using self-supervision to train the feature extractor, a generic pipeline considerably increases the performance of weakly supervised learning across three architectures and two datasets, and closes the gap with strongly-supervised models on Camelyon16. An in-domain feature extractor trained with MoCo v2 can therefore act as a drop-in replacement for any histology model currently relying on ImageNet pre-trained networks. Furthermore, the learned embedding space clusters histology tiles into biologically meaningful histological patterns, which could lead to new interactive tools for pathologists to explore WSIs and find novel biomarkers. Finally, by showing transfer learning capabilities, the proposed pipeline lays the foundation for a universal self-supervised histology feature extractor on H&E-stained slides.

### Example Tile Clusters

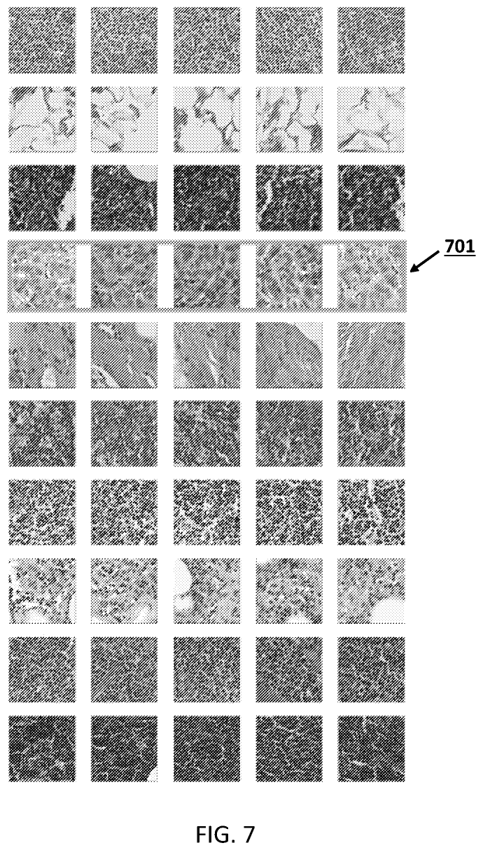

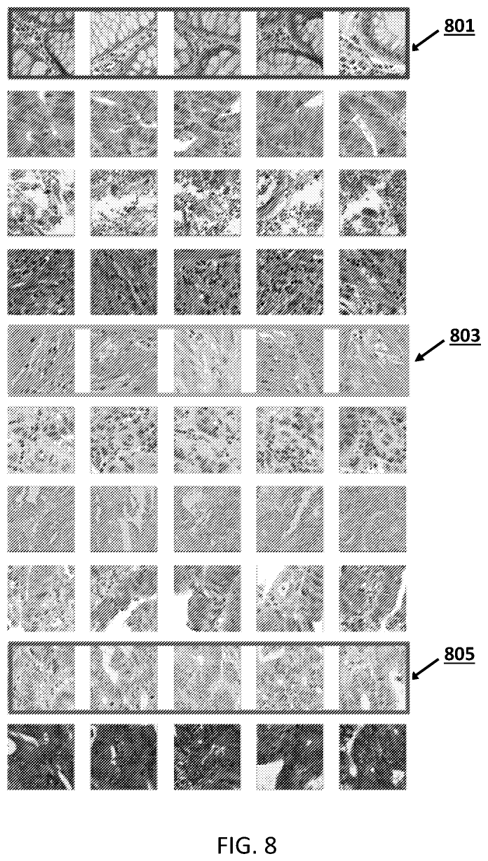

As discussed above, once clustering has been performed, the clusters can be annotated in order to identify them as meaningful groups. In two example embodiments, the five most representative tiles of each cluster can be seen in FIG. 7 for Camelyon16. Likewise, FIG. 8 shows the most representative clusters for TCGA-COAD.

With reference to FIG. 7, cluster 701 highlights the five most representative tiles from the showing tumoral tissue. FIG. 5C, above, provides an example of this cluster overlayed on a Camelyon16 slide. In the example shown in FIG. 7, the most representative tiles from 10 different clusters are shown, with the tiles corresponding to the cluster showing tumoral tissue highlighted at 701.

With reference to FIG. 8, cluster 801 shows the five most representative tiles with mucusa with normal intestinal glands, cluster 803 shows the five most representative tiles with muscularis mucosae and submucosa, and cluster 805 shows the five most representative tiles with tumoral tissue. FIGS. 6B-6D provide an example of these three clusters overlayed on a TCGA-COAD slide.

### Example Architecture 1

In this example, a set of one-dimensional embeddings is computed for the tile features using a multi-layer perceptron (MLP) with 128 hidden neurons. R=5 top and bottom scores are selected and averaged.

TABLE 4

| Layer | Type |
|---|---|
| 1 | fc-128 |
| 2 | fc-1 |
| 3 | extreme-scores-5 |
| 4 | average + sigmoid |

### Example Architecture 2

In this example, a set of one-dimensional embeddings is computed for the tile features. R=5 top and bottom scores are selected, and a MLP with 200 and 100 hidden neurons and sigmoid activations is applied to the results.

TABLE 6

| Layer | Type |
|---|---|
| 1 | fc-1 |
| 2 | extreme-scores-5 |
| 3 | fc-200 + sigmoid |
| 4 | fc-100 + sigmoid |
| 5 | fc-1 + sigmoid |

### Example Architecture 3

In this example, a linear layer with 128 neurons is applied to the embedding, followed by a Gated Attention layer with 128 hidden neurons. A MLP with 128 and 64 hidden neurons and ReLU activations is applied to the results.

TABLE 5

| Layer | Type |
|---|---|
| 1 | fc-128 |
| 2 | gated-attention-128 |
| 3 | fc-128 + relu |
| 4 | fc-64 + relu |
| 5 | fc-1 + sigmoid |

In the examples described herein, a maximum of 10,000 tiles of size 224×224 at a zoom level of 0.5 microns per pixel is extracted from each WSI. When the WSI contains less than 10,000 tiles all tiles available are taken, otherwise 10,000 tiles are randomly sampled.

In some embodiments, training is performed for 15 epochs with a batch size of 16, with a learning rate of 0.001, betas=(0.9, 0.999), epsilon=1e-8 and no weight decay.

TABLE 7

| Type | Parameters |
|---|---|
| RandomRotate | 90°, 170°, 280° |
| RandomVerticalFlip | — |
| RandomHorizontalFlip | — |
| RandomResizedCrop | scale = (0.2, 1.0) |
| ColorJitter | brightness = 0.8 |
| | contrast = 0.8 |
| | saturation = 0.8 |
| | hue = 0.2 |
| RandomGrayscale | — |
| GaussianBlur | sigma_min = 0.1 |
| | sigma_max = 2.0 |

The training dataset on Camelyon16 contains 2,646,426 million tiles, while the one on TCGA-COAD contains 2,486,159 million tiles. The data augmentation pipeline used during training is described in Table 7. In one embodiment, training is performed for 200 epochs with a batch size of 4,096 over 16 NVIDIA Tesla V100. The LARS optimizer can be used, with a learning rate of 0.2, momentum of 0.9, weight decay of 1.5e-6 and eta of 1e-3.

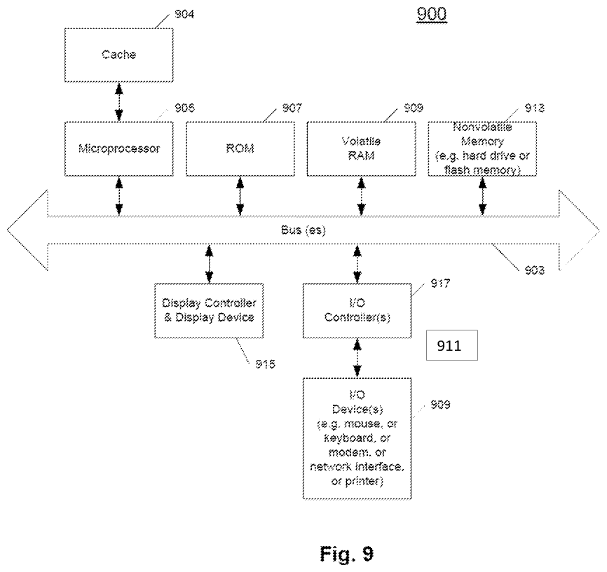

FIG. 9 shows one example of a data processing system 900, which may be used with one embodiment of the present invention and to perform the methods and techniques described herein. Note that while FIG. 9 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 9, the computer system 900, which is a form of a data processing system, includes a bus 903 which is coupled to a microprocessor(s) 905 and a ROM (Read Only Memory) 907 and volatile RAM 909 and a non-volatile memory 913. In some embodiments, the memory 913 includes a non-transitory computer readable medium storing code instructions for the implementation of one or more portions of the methods and techniques described herein. The microprocessor 905 may include one or more CPU(s), GPU(s), a specialized processor, and/or a combination thereof. The microprocessor 905 may be in communication with a cache 904, and may retrieve the instructions from the memories 907, 909, 913 and execute the instructions to perform operations described above. The bus 903 interconnects these various components together and also interconnects these components 905, 907, 909, and 913 to a display controller and display device 915 and to peripheral devices such as input/output (I/O) devices 911 which may be mice, keyboards, modems, network interfaces, printers and other devices which are well known in the art. Typically, the input/output devices 911 are coupled to the system through input/output controllers 917. The volatile RAM (Random Access Memory) 909 is typically implemented as dynamic RAM (DRAM), which requires power continually in order to refresh or maintain the data in the memory.

The nonvolatile memory 913 can be, for example, a magnetic hard drive or a magnetic optical drive or an optical drive or a DVD RAM or a flash memory or other types of memory systems, which maintain data (e.g. large amounts of data) even after power is removed from the system. Typically, the nonvolatile memory 913 will also be a random access memory although this is not required. While FIG. 9 shows that the nonvolatile memory 913 is a local device coupled directly to the rest of the components in the data processing system, it will be appreciated that the present invention may utilize a nonvolatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “segmenting,” “tiling,” “receiving,” “computing,” “extracting,” “processing,” “applying,” “augmenting,” “normalizing,” “pre-training,” “sorting,” “selecting,” “aggregating,” “sorting,” “clustering,” “analyzing,” “predicting,” “training,” “performing data augmentation,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method of training a feature extractor, the method comprising:
receiving a training set of histology images, wherein each image in the training set of histology images is annotation-free;
tiling the training set of histology images into a set of tiles;
performing data augmentation on the set of tiles to generate at least two batches of tiles, wherein each batch of tiles includes randomly augmented views of the original set of tiles;
extracting a first set of features from the first batch of tiles; extracting a second set of features from the second batch of tiles; and
training the feature extractor using a contrastive loss between pairs of the first set of features and the second set of features to bring matching pairs of tiles closer and different pairs of tiles further apart.

2-7. (canceled)

8. A method of training a weakly-supervised machine learning model using the trained feature extractor, the method comprising:
receiving a first set of histology images having global labels;
applying a trained feature extractor to the first set of histology images to generate a plurality of extracted features, wherein the trained feature extractor set is trained using a contrastive loss between pairs of the first set of features and the second set of features extracted from a second set of histology images and the second set of histology images are annotation-free; and
training the weakly-supervised machine learning model using the plurality of extracted features extracted from the first set of histology images having global labels.

9-13. (canceled)

14. A system for training a feature extractor, comprising:
an image processor within a processing device configured to:
receive a training set of histology images, wherein each image in the training set of histology images is annotation-free,
tile the training set of histology images into a set of tiles, and
perform data augmentation on the set of tiles to generate at least two batches of tiles, wherein each batch of tiles includes randomly augmented views of the original set of tiles;
at least one feature extractor configured to extract a first set of features from the first batch of tiles and extract a second set of features from the second batch of tiles;
wherein the processor is further configured to train the feature extractor using a contrastive loss between pairs of the first set of features and the second set of features to bring matching pairs of tiles closer and different pairs of tiles further apart.

15-20. (canceled)

21. A system for training a weakly-supervised machine learning model using the trained feature extractor, the system comprising:
an input for receiving a first set of histology images having global labels; and
the trained feature extractor of any one of claim 14 configured to generate a plurality of extracted features from the first set of histology images;
wherein the processor is further configured to train the weakly-supervised machine learning model using the plurality of extracted features extracted from the first set of histology images having global labels.

22-26. (canceled)

27. A method of determining a plurality of regions of interest in an input histology image, the method comprising:
receiving an input histology image;
tiling the input histology image into a set of tiles;
for each tile, extracting a feature of that tile by applying a trained feature extractor, the trained feature extractor trained with an unsupervised machine learning algorithm using a training set of images;
clustering the extracted features to assign each of the set of tiles to one of a plurality of regions of interest for each tile; and
outputting the plurality of regions of interest.

28. The method of claim 27, wherein each of the images in the training set of images are annotation-free.

29. The method of claim 27, wherein the input histology image and the training set of images are from the same domain.

30. The method of claim 27, wherein the clustering is a K-Means clustering.

31. The method of claim 27, wherein the input histology image is a whole slide image.

32. The method of claim 27, wherein the input histology image is derived from a patient tissue sample.

33. The method of claim 32, wherein the patient tissue sample is known or suspected to contain a tumor.

34. The method of any one of claim 27, wherein the unsupervised machine learning algorithm is a self-supervised machine learning algorithm.

35. The method of any one of claim 27, wherein the unsupervised machine learning algorithm is a contrastive loss machine learning algorithm including one of Momentum Contrast or Momentum Contrast v2.

36. The method of any one of claim 27, wherein the trained feature extractor is a ResNet type of feature extractor.

37. The method of any one of claim 27, further comprising:
removing background segments from the input histology image.

38. The method of any one of claim 27, further comprising:
annotating at least one cluster of extracted features.

39. The method of any one of claim 27, further comprising:
quantifying the input histology image by a level of expression of a plurality of clusters.

40. A non-transitory machine-readable medium with a memory storing code instructions which, when executed by a processor, cause the processor to perform operations for determining a plurality of regions of interest in an input histology image, the operations comprising:
receiving an input histology image;
tiling the input histology image into a set of tiles;
for each tile, extracting a feature of that tile by applying a trained feature extractor, the trained feature extractor trained with an unsupervised machine learning algorithm using a training set of images;
clustering the extracted features to assign each of the set of tiles to one of a plurality of regions of interest for each tile; and
outputting the plurality of regions of interest.

41-51. (canceled)

52. A system for determining a plurality of regions of interest in an input histology image, comprising:
an image processor within a processing device, the image processor configured to receive an input histology image and tile the input histology image into a set of tiles;
a trained feature extractor for extracting features from each tile, the trained feature extractor trained with an unsupervised machine learning algorithm using a set of training images;
a clustering module within the processing device, the clustering module configured to cluster the extracted features to assign each tile to one of a plurality of regions of interest for each tile; and
an output device to output the plurality of regions of interest.

53-64. (canceled)
